(19) United States
(12) Patent Application Publication
(10) Pub. No.: US 2026/0222184 A1
(43) Pub. Date: Jul. 30, 2026

(54) SECURE NETWORK DEVICE ACCESS OVER A WIRELESS PERSONAL AREA NETWORK BY A MOBILE DEVICE WITH NETWORK CONNECTIVITY

(71) Applicant: Cisco Technology, Inc., San Jose, CA (US)

(72) Inventors: Elango GANESAN, Portola Valley, CA (US); Michael FREED, Pleasanton, CA (US); Ruben Erick ESCOLERO, San Francisco, CA (US); Sravanth YAJAMANAM, San Jose, CA (US)

(21) Appl. No.: 19/040,387

(22) Filed: Jan. 29, 2025

(51) Int. Cl. H04L 9/08; H04W 12/041; H04W 12/08

(52) U.S. Cl. CPC H04L 9/085; H04W 12/041; H04W 12/08; H04L 2209/80

(57) ABSTRACT

In one embodiment, a management device receives a request from an accessing device over a computer network to access a specific network device via a local wireless communication link. The management device sends a first nonce along with a shared secret to the accessing device to forward it to the specific network device over the local wireless communication link. The management device receives a second nonce sent by the specific network device in response to validating the shared secret, sent via the local wireless communication link to the accessing device and forwarded over the computer network to the management device. In response to validating the second nonce, the management device sends an acknowledgment message to the accessing device to forward it on to the specific network device to cause it to validate the acknowledgment message and establish a trusted connection with the accessing device over the local wireless communication link.

### TECHNICAL FIELD

The present disclosure relates generally to computer networks, and, more particularly, to secure network device access over a wireless personal area network by a mobile device with network connectivity.

### BACKGROUND

In Operational Technology (OT) environments, network devices are often located in challenging and inaccessible places, such as locked cabinets or mounted on poles. When connectivity issues arise, troubleshooting these devices can be cumbersome, as technicians typically rely on physical console cables to access and resolve issues. This method presents logistical challenges, particularly when dealing with devices in difficult-to-reach locations, impeding efficient operations.

To address this problem, Bluetooth Low Energy (BLE) technology has emerged as a solution for wireless device access. BLE eliminates the need for physical connections, allowing OT personnel to troubleshoot devices more easily. Some industry players have integrated BLE to provide an always-on console port for enhanced accessibility. However, while convenient, this approach introduces significant security concerns. A continuously accessible BLE console, secured only by standard BLE authentication, poses vulnerabilities that could expose enterprises to potential threats.

Key weaknesses of the standard BLE approach include reliance on basic authentication methods, which are easy for users to memorize and misuse, allowing unauthorized access. Additionally, BLE's standard security measures have been repeatedly compromised, leaving devices exposed to malicious actors. Both security experts and customers have raised concerns about the inadequacy of this level of protection, highlighting the need for more robust and secure solutions in OT environments.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an architecture for secure network device access;

FIGS. 4A-4B illustrate an example flow of an end-to-end encryption between the backend servers, user device and the network device;

FIG. 5 illustrates an example simplified procedure for secure network device access over a wireless personal area network from the perspective of a management device;

FIG. 6 illustrates an example simplified procedure for secure network device access over a wireless personal area network from the perspective of an accessing device; and

FIG. 7 illustrates an example simplified procedure for secure network device access over a wireless personal area network from the perspective of a network device.

### DESCRIPTION OF EXAMPLE EMBODIMENTS

### Overview

According to one or more embodiments of the disclosure, a management device receives a request from an accessing device over a computer network to access a specific network device via a local wireless communication link. The management device sends a first nonce along with a shared secret to the accessing device to forward the first nonce to the specific network device over the local wireless communication link. The management device receives a second nonce sent by the specific network device in response to the specific network device validating the shared secret, the second nonce sent via the local wireless communication link to the accessing device and then forwarded over the computer network to the management device. In response to validating the second nonce, the management device sends an acknowledgment message over the computer network to the accessing device to then forward the acknowledgment message on to the specific network device to cause the specific network device to validate the acknowledgment message and establish a trusted connection with the accessing device over the local wireless communication link.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

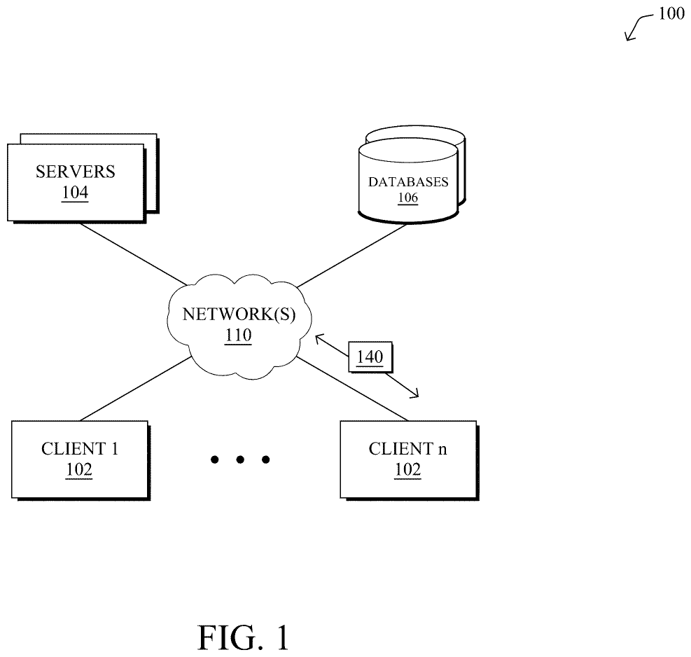

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

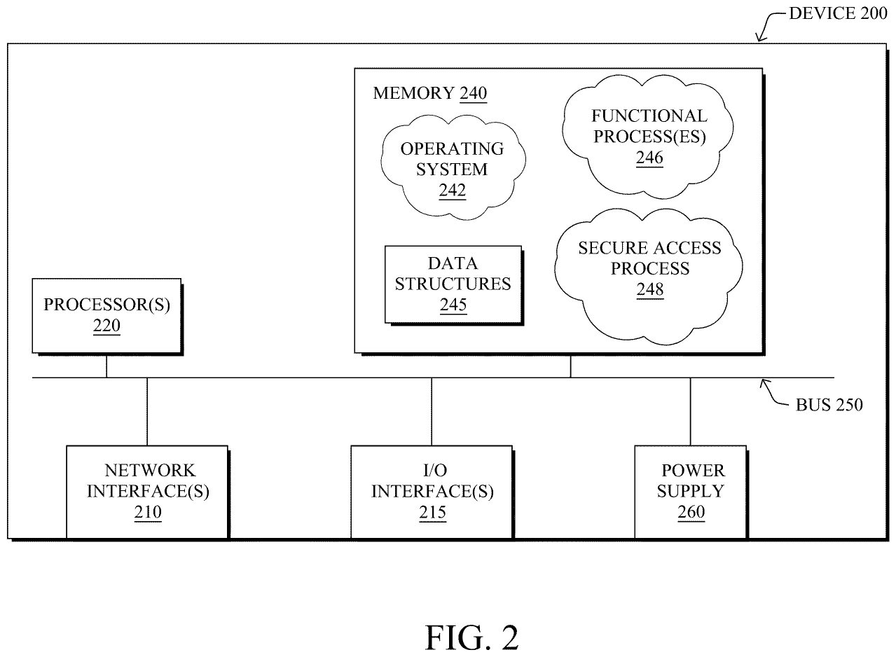

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a secure access process (process 248), as described herein, each of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

### Secure Network Device Access Over A Wireless Personal Area Network By A Mobile Device With Network Connectivity

As noted above, current approaches to troubleshooting network devices in OT environments can be difficult as network devices can be located in difficult-to-reach areas, which can present significant challenges because physical access is often difficult and time-consuming. Further, such approaches require on-site presence, which can lead to operational delays, increased costs, and potential service disruptions. Additionally, harsh environmental conditions or safety concerns, such as working at heights or in hazardous zones, can further complicate access to these network devices. The inability to efficiently troubleshoot these systems can result in prolonged downtime, negatively impacting industrial processes and critical infrastructure.

While Bluetooth Low Energy (BLE) technology offers a wireless alternative to facilitate remote access, it also introduces serious security risks. For example, a continuously accessible BLE console may be susceptible to unauthorized access, particularly when protected only by basic authentication methods, which can be easily exploited. Attackers could potentially intercept BLE communications, execute replay attacks, or gain persistent access to sensitive network infrastructure. Furthermore, BLE security vulnerabilities have been well-documented, with standard implementations proving inadequate in safeguarding against sophisticated cyber threats. These risks raise concerns among both security professionals and enterprises, emphasizing the need for a more robust access control mechanism that balances convenience with security. As OT environments become increasingly interconnected, addressing these vulnerabilities is critical to ensuring the reliability and security of industrial networks.

The techniques herein are directed to implementations that not only enhance user accessibility by enabling access to the device's console via BLE but also can ensure enterprise-grade security. Aspects of the disclosure address traditional BLE shortcomings by implementing an approval workflow that requires users to obtain prior approval from a management system before accessing the console over BLE, adding another layer of authentication, authorization, and encryption on top of standard BLE. As discussed herein this prior approval can occur over a network as part of the access session while the accessing device has network connectivity.

Specifically, according to one or more embodiments of the disclosure as described in detail below, a management device receives a request from an accessing device over a computer network to access a specific network device via a local wireless communication link. The management device sends a first nonce along with a shared secret to the accessing device to forward the first nonce to the specific network device over the local wireless communication link. The management device receives a second nonce sent by the specific network device in response to the specific network device validating the shared secret, the second nonce sent via the local wireless communication link to the accessing device and then forwarded over the computer network to the management device. In response to validating the second nonce, the management device sends an acknowledgment message over the computer network to the accessing device to then forward the acknowledgment message on to the specific network device to cause the specific network device to validate the acknowledgment message and establish a trusted connection with the accessing device over the local wireless communication link.

Illustratively, the techniques described herein may be performed by hardware, software, and/or firmware, such as in accordance with secure access process (e.g., process 248), which may include computer executable instructions executed by the processor(s) 220 (or independent processor of network interfaces 210) to perform functions relating to the techniques described herein.

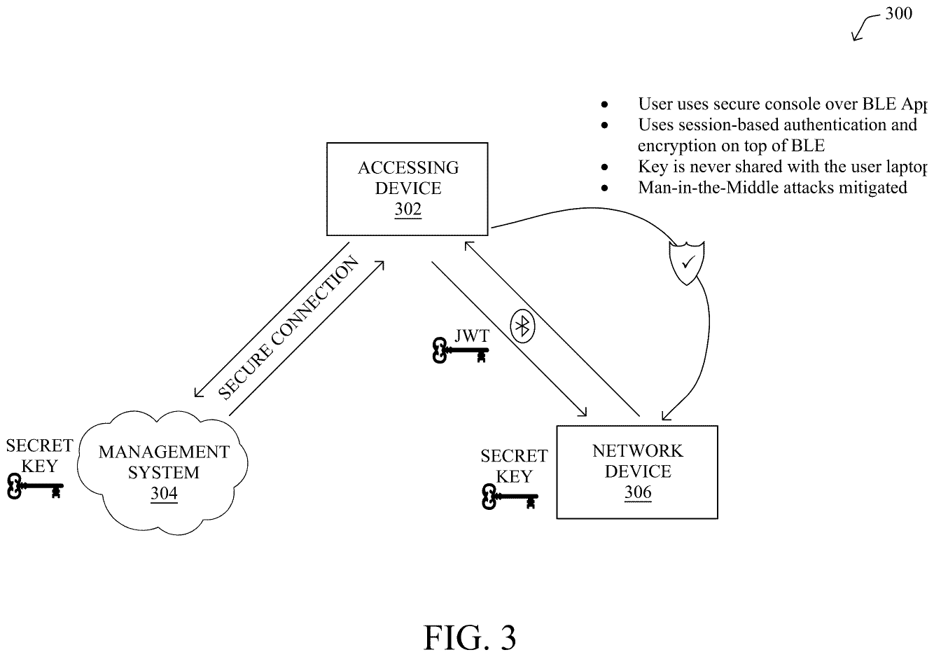

Operationally, FIG. 3 illustrates an example of an architecture for secure network device access. As shown in FIG. 3, the architecture 300 may include accessing device 302, management system 304, and network device 306. As shown in FIG. 3, the accessing device 302 (e.g., a user device) can be in communication with the management system 304 via a secured connection and can be in communication with the network device 306 via a Bluetooth (e.g., BLE) communication path.

In some implementations, the accessing device 302 can be a laptop. This can allow for different technicians to access and/or manage the console (e.g., the management system 304). However, because different technicians may use different devices, or may even change or upgrade their devices over time, it is imperative that the laptop is not associated with a malicious or hostile user.

It is noted that, in accordance with the disclosure:
Implementations described herein leverage integration of Just-in-Time approval and pre-approval processes, which facilitate device access without network connectivity through Bluetooth Low Energy (BLE) technology.
Implementations described herein may be useful for access to console via BLE, as well as other paradigms, including serial/USB ports.
As discussed herein, the system can be designed with a two-pronged strategy: one is an always-active console, and the other is a BLE feature that activates only when the device loses internet connection for a configurable amount of time.
In addition, implementations herein can ensure that sensitive information, such as permanent pre-shared secrets or private keys, remains concealed from customer devices such as laptops, tablets, or other mobile devices.

If the network device 306 (e.g., a router, switch, etc.) has IP based connectivity to a backend server, an approval flow can be constructed. When a user tries to login, the network device 306 can check to see if the user is an authorized user. However, in scenarios in which troubleshooting is to be performed and, hence, the network device 306 may not have network connectivity, it may be difficult to construct the approval flow. Accordingly, aspects of the present disclosure provide solutions to this scenario in which the network device 306 may not have network connectivity, but an approval flow needs to be constructed.

As will be appreciated, while provisioning a network device (e.g., the network device 306) with a backend management system (e.g., the management system 304), secret information may be shared between network device and the backend management system. This secret information, which is essential for authentication and encryption, could be in the form of a Pre-Shared Key (PSK), asymmetric key pairs (public/private keys), or a digital certificate, among others. Implementing this secure key exchange is pivotal for establishing a trusted connection. It allows customer devices such as laptops or smartphones (e.g., accessing device 302) to communicate securely with the network device, with the backend management server functioning as a trusted intermediary. This trust establishment is essential for ensuring secure communication within the network. Although there are many ways to facilitate sharing and storing of this secret information, in some implementations, an integrated BLE chip may be installed on the console/network device (e.g., the network device 306), while in other implementations, a pre-installed external BLE dongle may be used to provide connectivity.

The following is an example high-level workflow in accordance with the disclosure.
1. An application runs on the customer's mobile device or laptop.
2. The customer submits a request to the management system for accessing a specific network device.
3. The admin can approve or deny this request.
4. A trust relationship is established between the customer's device and the network device via a three-way handshake facilitated by the management system.
5. Upon successful establishment of trust, the application gains access to the console of the network device.
6. The technician can now execute commands necessary for the troubleshooting process.

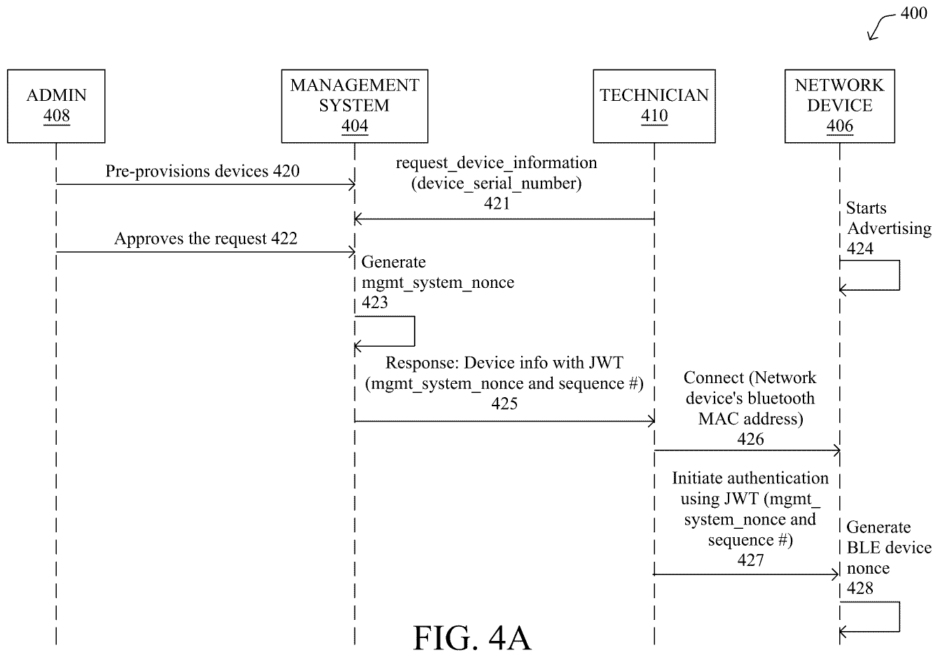

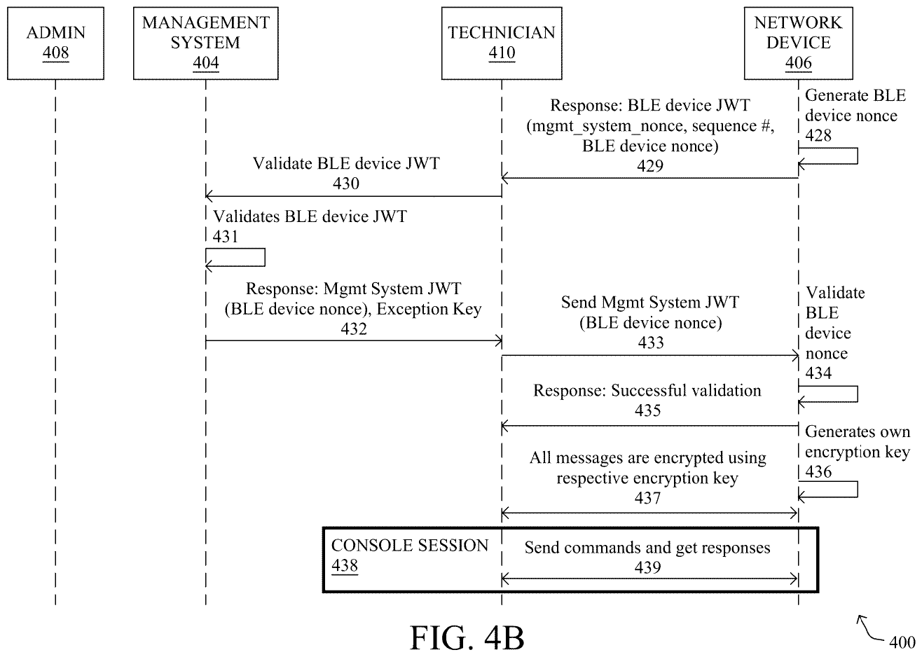

FIGS. 4A-4B illustrate an example flow of an end-to-end encryption between the backend servers, user device and the network device. The flow 400 can correspond to a use case where a device that is integral to an OT environment experiences a network connectivity loss. A technician is tasked with troubleshooting this issue and aims to use implementations of the present disclosure for this process. Two potential scenarios might unfold during this process.
Customer uses a mobile device or laptop that has internet connectivity.
Customer uses a mobile device or laptop that lacks internet connectivity.

In the case of the first scenario where the network device has lost network connectivity and needs maintenance and the technician's mobile device or laptop has internet connection, a 3-way handshake with nonces for example JSON Web Token (JWT) can be utilized and the following steps may be performed:
1. Technician runs an application on his/her device (laptop/tablet) and login into management system. Requests for an approval from admin to access a device.
2. Admin approves the request.
3. The Management system generates JWT nonce signed with pre-shared key and sequence number and forwards response to technician's laptop.
4. Technician's laptop initiates connection to the network device using JWT nonce.
5. The Network device generates its own nonce and sends it back to the laptop which is forwarded to the management system.
6. The management system verifies the JWT with nonce, generates encryption key based on both nonces and pre-shared key and sends it along with device nonce back to the laptop.
7. Laptop forwards this response to the network device and after successful validation, a trusted connection is established between the laptop and the network device.
8. The Network device generates its own encryption key and traffic between laptop and the network device is encrypted using respective encryption keys.
9. Technicians can now execute commands necessary for the troubleshooting process.

As a secondary example flow of an end-to-end encryption between backend server and a network device with a user laptop acting as a forwarder/gateway device (e.g., an accessing device), where the user and the devices are onboarded onto central server), the following steps can be performed:
1. User Laptop (Logs into Central Microservice)<--->Central Micro-Service [passes Central API key]//specify SSH or some other secure connection.
2. User Laptop GET/devices/list from Central Micro-Service—Selects Device to troubleshoot—GET/devices/serialNum Central returns device parameters BLE MAC Addr and JWT (cs_nonce).
3. User Laptop connects using device parameters and sends JWT<-->RasPi receives JWT (cs_nonce) returns JWT (cs_nonce, ble_nonce) <BLE Unsecure>.
4. User laptop receives JWT (cs_nonce, ble_nonce) and sends to Central<---->Central receives, confirms signature and cs_nonce, creates Sym session encryption key. Sends JWT (ble_nonce) and session key <ssh>.
5. User Laptop sends JWT (ble_nonce)<---->network device checks ble_nonce and time, then generates sym session encryption key (Graphic: Secret+Nonces) do it above too.
6. Serial access allowed (shield up) Communication between network device and Client with Symm encryption using session keys.

Returning back to the flow 400, in some implementations, an admin 408 can pre-provision device to the management system 404 as shown at operation 420. The management system 404 can be analogous to the management system 304 of FIG. 3. In addition, a technician 410 can request device information from the management system 404, as shown at operation 421. In some implementations, the device information can include a serial number of the device. Next, admin 408 can approve the request for the device information, as shown at operation 422.

The management system 404 can then generate one or more nonces, as shown at operation 423. These nonce(s) can be referred to herein as “management system nonce(s)” and can be used by the management system 404 in accordance with the disclosure. Further, as shown in FIGS. 4A-4B, the process to generate these nonce(s) can be iterative or can be performed once to generate the management system nonce. Prior to this process and/or concurrently, the network device 406 can begin advertising, as shown at operation 424.

At operation 425, a response from the management system 404 can be sent to technician 410. As discussed above, the technician 410 can be provided with an accessing device (e.g., the accessing device 302 of FIG. 3, which can be a laptop, smartphone, tablet, etc.). In some implementations, the response can include the device information requested at operation 421 in addition to the nonce(s) generated at operation 423. The response can be sent with JWT (e.g., JavaScript Object Notation (JSON) Web Token (JWT), as discussed herein. In addition, in some implementations, the response can include a sequence number.

At operation 426, the technician 410 can connect to the network device 406. In some implementations, the technician 410 connecting to the network device 406 can include connecting to the network device 406 via BLE using a MAC address associated with the network device 406. At operation 427, the technician 410 can initiate authentication to the network device 406 using JWT, which, as described above, can include the nonce(s) generated at operation 423 and/or operation 425, as well as the sequence number, which was determined at operation 425.

At operation 428 (connecting between FIG. 4A and FIG. 4B), the network device 406 can generate a nonce. As described herein, the nonce generated at operation 428 by the network device 406 can be a BLE device nonce, although implementations are not so limited. At operation 429, the network device 406 can send a response to the technician 410. This response can include a JWT nonce (e.g., the management system nonce), the sequence number, and the BLE device nonce generated by the network device 406 at operation 428.

At operation 430, the technician 410 can request validation of the BLE device from the management system 404. The validation request can include a JWT nonce (e.g., the management system nonce), the sequence number, and/or the BLE device nonce generated by the network device 406 at operation 428. At operation 431, the management system 404 can validate the request for validation of the BLE device. Provided that this validation is successful, at operation 432, the management system 404 can provide a response including the JWT nonce (e.g., the management system nonce), the BLE device nonce, and/or an encryption key.

Based on this response, at operation 433, the technician 410 can send the management system response (e.g., the JWT nonce, the BLE device nonce, and/or the encryption key) to the network device 406. The network device 406 can then validate the BLE device nonce at operation 434. In response to successful validation of the BLE nonce at operation 434, the network device 406 can, at operation 435, send a successful validation response to the technician 410.

At operation 436, the network device 406 can generate an encryption key. This encryption key can be associated with the network device 406 and may be held privately by the network device 406 for validation of other keys/encryption methodologies described herein or known in the art. Now, at operation 437, all messages between the technician 410 (and hence, the accessing device used by the technician) can be encrypted using the encryption keys generated during the flow 400.

Finally, as shown at block 438, where a console session is initiated, verified, and encrypted in accordance with the disclosure, commands and responses may be transmitted between the technician 410 and the network device 406, as shown at operation 439.

In some implementations, a graphical user interface (GUI) can be provided to the technician 410. The GUI can be embedded in a browser screen, or other suitable display format.

In summary of the foregoing, in some implementations, aspects of the present disclosure can allow a user to access a secure console over BLE. Such user sessions can include session-based authentication and encryption on top of the BLE. The secure keys and/or authentication mechanisms may never be shared with the accessing device and, hence, the technician 410 may never be able to access these secure keys and/or authentication mechanisms. These and other features describe herein can mitigate “man-in-the-middle” attacks, as well as other attacks from various nefarious entities.

In furtherance to the techniques, implementations herein can provide for situations in which an admin sets up the network and can therefore provide keys (e.g., security keys, encryption keys, etc.) that can be “pre-shared” between a central server, the management device, the network device, and/or the accessing device. This “pre-sharing” of keys can be provided on the backend in accordance with the disclosure. In some implementations, one or more technicians may already also be verified on the backend to access the network for various troubleshooting purposes in accordance with the disclosure. However, in an effort to further improve the security features described herein, granular policies may be associated with various technicians. For example, a particular technician may be granted a window of time to access and/or troubleshoot the network, etc.

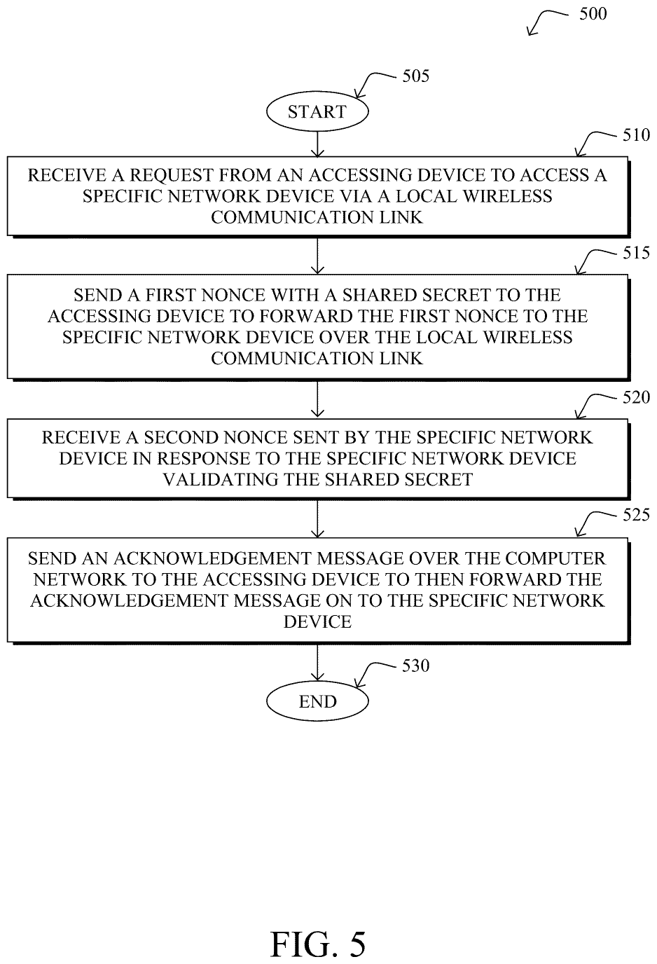

In closing, FIG. 5 illustrates an example simplified procedure for secure network device access over a wireless personal area network from the perspective of a management device in accordance with one or more embodiments described herein, particularly from the perspective of a device. For example, a non-generic, specifically configured device (e.g., device 200, an apparatus) may perform procedure 500 by executing stored instructions (e.g., process 248). The procedure 500 may start at step 505, and continues to step 510, where, as described in greater detail above, a request from an accessing device to access a specific network device via a local wireless communication link is received at a management device over a computer network. In some implementations, the specific network device can be disconnected from the computer network.

Procedure 500 may continue to step 515, where, as described in greater detail above, the management device can send, based on approval of the request, a first nonce with a shared secret to the accessing device to forward the first nonce to the specific network device over the local wireless communication link. In some implementations, the shared secret is selected from a group consisting of: a pre-shared key, asymmetric key pairs, a digital certificate, and a sequence number.

Procedure 500 may continue to step 520, where, as described in greater detail above, the management device can receive a second nonce sent by the specific network device in response to the specific network device validating the shared secret. The second nonce can be sent via the local wireless communication link to the accessing device and then forwarded over the computer network to the management device.

Procedure 500 may continue to step 525, where, as described in greater detail above, the management device can send, in response to verifying the second nonce, an acknowledgment message over the computer network to the accessing device to then forward the acknowledgment message on to the specific network device to cause the specific network device to validate the acknowledgment message and establish a trusted connection with the accessing device over the local wireless communication link. In some implementations, the acknowledgment message carries a first encryption key generated by the management device based on the first nonce and the second nonce and the shared secret.

In some implementations, procedure 500 can further include sending a granular policy of the management device within the first nonce to cause the specific network device to enforce the granular policy on the trusted connection, wherein the granular policy is selected from a group consisting of: a user-based policy, an access level based policy, a time based policy, and any combination thereof.

In some implementations, the first nonce and the second nonce each comprise a JavaScript Object Notation (JSON) Web Token (JWT).

Procedure 500 may end at step 530.

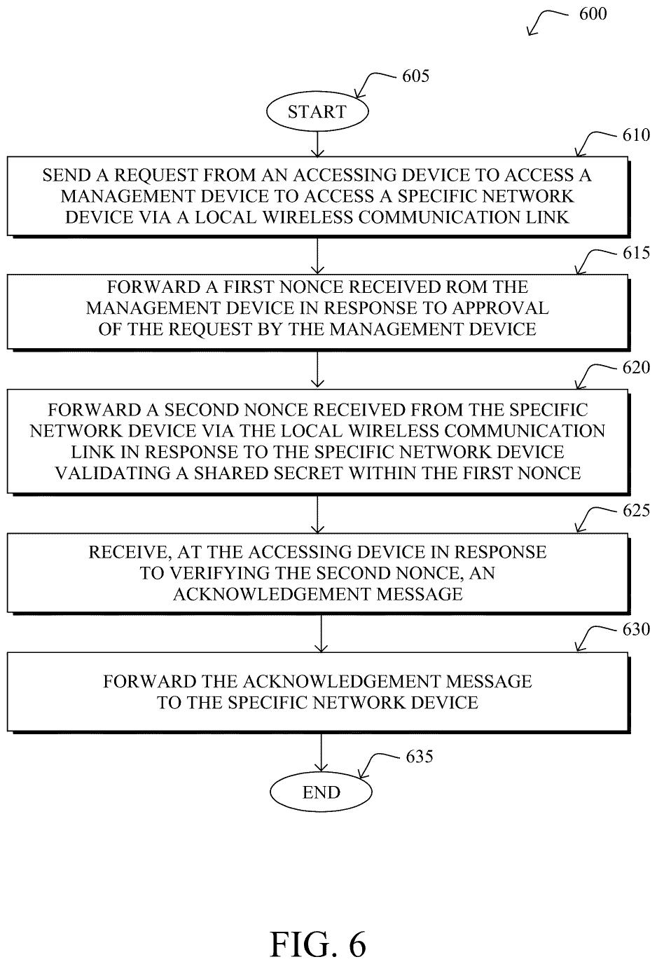

In addition, FIG. 6 illustrates an example simplified procedure for secure network device access over a wireless personal area network from the perspective of an accessing device in accordance with one or more embodiments described herein, particularly from the perspective of a device. For example, a non-generic, specifically configured device (e.g., device 200, an apparatus) may perform procedure 600 by executing stored instructions (e.g., process 248). The procedure 600 may start at step 605, and continues to step 610, where, as described in greater detail above, an accessing device sends, over a computer network, a request to a management device to access a specific network device via a local wireless communication link. In some implementations, the specific network device can be disconnected from the computer network. The accessing device can be selected from a group consisting of: a mobile phone, a tablet, and a laptop, although it will be appreciated that these are non-limiting examples of various accessing devices.

In some implementations, sending the request to the management device can further include logging into a management dashboard of the management device; and indicating the request to access the specific network device from within the management dashboard.

Procedure 600 may continue to step 615, where, as described in greater detail above, the accessing device forwards, to the specific network device over the local wireless communication link, a first nonce received from the management device in response to approval of the request by the management device.

Procedure 600 may continue to step 620, where, as described in greater detail above, the accessing device forwards, to the management device over the computer network, a second nonce received from the specific network device via the local wireless communication link in response to the specific network device validating a shared secret within the first nonce.

Procedure 600 may continue to step 625, where, as described in greater detail above, the accessing device receives, from the management device over the computer network in response to verifying the second nonce, an acknowledgment message. In some implementations, the acknowledgment message can include a first encryption key. In such implementations, procedure 600 can further include receiving, from the specific network device in response to establishing the trusted connection, a second encryption key, wherein traffic on the trusted connection is encrypted using the first encryption key and the second encryption key.

Procedure 600 may continue to step 630, where, as described in greater detail above, the accessing device forwards the acknowledgment message to the specific network device to cause the specific network device to validate the acknowledgment message and establish a trusted connection with the accessing device over the local wireless communication link.

In some implementations, procedure 600 can further include accessing an admin console of the specific network device via the trusted connection for local management of the specific network device by the accessing device.

In some implementations, procedure 600 can further include providing, by the accessing device, access for the specific network device to the computer network via the trusted connection for remote management of the specific network device by a remote management application over the computer network.

Procedure 600 may end at step 635.

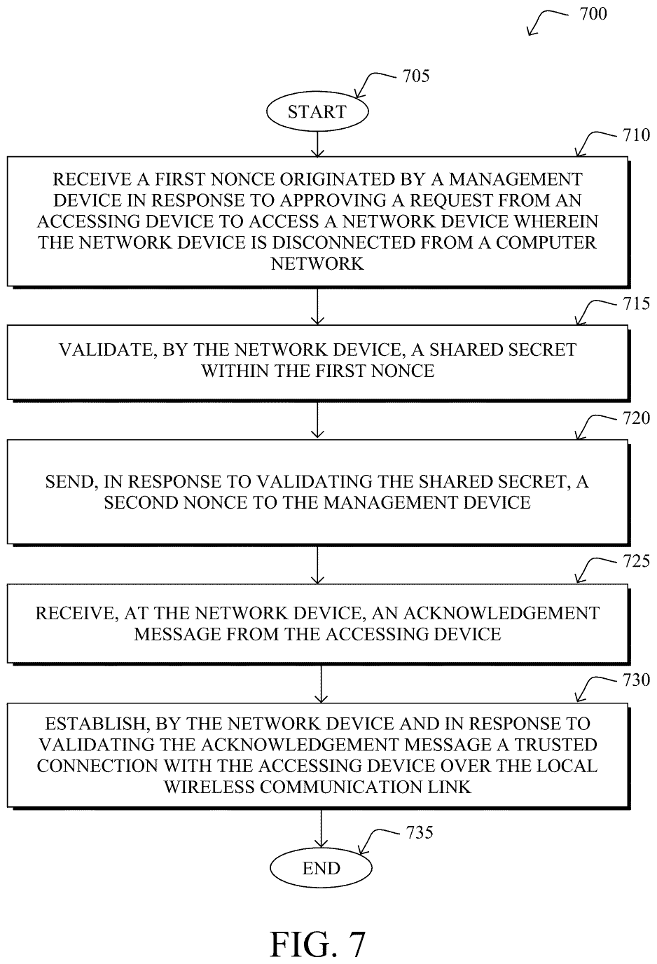

Moreover, FIG. 7 illustrates an example simplified procedure for secure network device access over a wireless personal area network from the perspective of a network device in accordance with one or more embodiments described herein. For example, a non-generic, specifically configured device (e.g., device 200, an apparatus) may perform procedure 700 by executing stored instructions (e.g., process 248). The procedure 700 may start at step 705, and continues to step 710, where, as described in greater detail above, a first nonce is received at a network device and from an accessing device over a local wireless communication link. The first nonce is originated by a management device in response to approving a request from the accessing device to access the network device via the local wireless communication link. In some implementations, the network device is disconnected from a computer network. As discussed above, the network device can be selected from a group consisting of: a wireless network access point, a router, and a switch, although implementations are not so limited.

In some implementations, the local wireless communication link on the network device can be enabled via one of either a pre-installed wireless link on the network device or an external wireless link dongle plugged into an external port of the network device.

Procedure 700 may continue to step 715, where, as described in greater detail above, the network device validates a shared secret within the first nonce. In some implementations, the shared secret is selected from a group consisting of: a pre-shared key, asymmetric key pairs, or a digital certificate, further comprising validation of the shared secret by the network device.

Procedure 700 may continue to step 720, where, as described in greater detail above, a second nonce is sent, from the network device and in response to validating the shared secret, to the management device via the accessing device over the local wireless communication link.

Procedure 700 may continue to step 725, where, as described in greater detail above, the network device receives, over the local wireless communication link, an acknowledgment message from the accessing device, the acknowledgment message originated by the management device over the computer network in response to verifying the second nonce. In some implementations, the acknowledgment message can include a first encryption key and the procedure 700 can further include sending, in response to establishing the trusted connection, a second encryption key, wherein traffic on the trusted connection is encrypted using the first encryption key and the second encryption key.

Procedure 700 may continue to step 730, where, as described in greater detail above, the network device establishes, in response to validating the acknowledgment message, a trusted connection with the accessing device over the local wireless communication link.

As discussed above, the first nonce and the second nonce may each comprise a JavaScript Object Notation (JSON) Web Token (JWT).

In some implementations, procedure 700 can further include providing access for the accessing device to an admin console of the network device via the trusted connection for local management of the network device by the accessing device. In addition to, or in the alternative, procedure 700 can further include accessing the computer network via the trusted connection for remote management of the network device by a remote management application over the computer network.

In some implementations, procedure 700 can further include receiving, within the first nonce, a granular policy of the management device, the granular policy selected from a group consisting of: a user-based policy, an access level based policy, a time based policy, and any combination thereof; and enforcing the granular policy on the trusted connection, as discussed above.

Procedure 700 may end at step 735.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

The techniques described herein, therefore, provide for secure network device access over a wireless personal area network by a mobile device with network connectivity. As discussed above, techniques described herein can improve accessibility to a console associated with a network device while ensuring enterprise-grade security. Accordingly, aspects of the disclosure address traditional BLE shortcomings by implementing an approval workflow that requires users to obtain prior approval from a management system before accessing the console over BLE, adding another layer of authentication, authorization, and encryption on top of standard BLE. In addition, the techniques described herein can mitigate man-in-the-middle attacks on networks, while providing technicians with the tools they need to work on networks.

Illustratively, the techniques described herein may be performed by hardware, software, and/or firmware, (e.g., an “apparatus”) such as in accordance with the secure access process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
receiving, at a management device and over a computer network, a request from an accessing device to access a specific network device via a local wireless communication link, wherein the specific network device is disconnected from the computer network;
sending, by the management device and based on approval of the request, a first nonce with a shared secret to the accessing device to forward the first nonce to the specific network device over the local wireless communication link;
receiving, at the management device, a second nonce sent by the specific network device, in response to the specific network device validating the shared secret, the second nonce sent via the local wireless communication link to the accessing device and then forwarded over the computer network to the management device; and
sending, by the management device and in response to verifying the second nonce, an acknowledgment message over the computer network to the accessing device to then forward the acknowledgment message on to the specific network device to cause the specific network device to validate the acknowledgment message and establish a trusted connection with the accessing device over the local wireless communication link.

2. The method as in claim 1, wherein the shared secret is selected from a group consisting of: a pre-shared key, asymmetric key pairs, a digital certificate, and a sequence number.

3. The method as in claim 1, wherein the first nonce and the second nonce each comprise a JavaScript Object Notation (JSON) Web Token (JWT).

4. The method as in claim 1, wherein the acknowledgment message carries a first encryption key generated by the management device based on the first nonce and the second nonce and the shared secret.

5. The method as in claim 1, further comprising:
sending a granular policy of the management device within the first nonce to cause the specific network device to enforce the granular policy on the trusted connection, wherein the granular policy is selected from a group consisting of: a user-based policy, an access level based policy, a time based policy, and any combination thereof.

6. A method, comprising:
sending, from an accessing device and over a computer network, a request to a management device to access a specific network device via a local wireless communication link, wherein the specific network device is disconnected from the computer network;
forwarding, by the accessing device and to the specific network device over the local wireless communication link, a first nonce received from the management device in response to approval of the request by the management device;
forwarding, by the accessing device and to the management device over the computer network, a second nonce received from the specific network device via the local wireless communication link in response to the specific network device validating a shared secret within the first nonce;
receiving, at the accessing device and from the management device over the computer network in response to verifying the second nonce, an acknowledgment message; and
forwarding, from the accessing device, the acknowledgment message to the specific network device to cause the specific network device to validate the acknowledgment message and establish a trusted connection with the accessing device over the local wireless communication link.

7. The method as in claim 6, wherein sending the request to the management device comprises:
logging into a management dashboard of the management device; and
indicating the request to access the specific network device from within the management dashboard.

8. The method as in claim 6, wherein the accessing device is selected from a group consisting of: a mobile phone, a tablet, and a laptop.

9. The method as in claim 6, further comprising:
accessing an admin console of the specific network device via the trusted connection for local management of the specific network device by the accessing device.

10. The method as in claim 6, further comprising:
providing, by the accessing device, access for the specific network device to the computer network via the trusted connection for remote management of the specific network device by a remote management application over the computer network.

11. The method as in claim 6, wherein the acknowledgment message includes a first encryption key, the method further comprising:
receiving, from the specific network device in response to establishing the trusted connection, a second encryption key, wherein traffic on the trusted connection is encrypted using the first encryption key and the second encryption key.

12. A method, comprising:
receiving, at a network device and from an accessing device over a local wireless communication link, a first nonce originated by a management device in response to approving a request from the accessing device to access the network device via the local wireless communication link, wherein the network device is disconnected from a computer network;
validating, by the network device, a shared secret within the first nonce;
sending, from the network device and in response to validating the shared secret, a second nonce to the management device via the accessing device over the local wireless communication link;
receiving, at the network device and over the local wireless communication link, an acknowledgment message from the accessing device, the acknowledgment message originated by the management device over the computer network in response to verifying the second nonce; and
establishing, by the network device and in response to validating the acknowledgment message, a trusted connection with the accessing device over the local wireless communication link.

13. The method according to claim 12, wherein the network device is selected from a group consisting of: a wireless network access point, a router, and a switch.

14. The method according to claim 12, wherein the local wireless communication link on the network device is enabled via one of either a pre-installed wireless link on the network device or an external wireless link dongle plugged into an external port of the network device.

15. The method according to claim 12, wherein the shared secret is selected from a group consisting of: a pre-shared key, asymmetric key pairs, or a digital certificate, further comprising validation of the shared secret by the network device.

16. The method according to claim 12, wherein the first nonce and the second nonce each comprise a JavaScript Object Notation (JSON) Web Token (JWT).

17. The method according to claim 12, further comprising:
providing access for the accessing device to an admin console of the network device via the trusted connection for local management of the network device by the accessing device.

18. The method according to claim 12, further comprising:
accessing the computer network via the trusted connection for remote management of the network device by a remote management application over the computer network.

19. The method according to claim 12, wherein the acknowledgment message includes a first encryption key, the method further comprising:
sending, in response to establishing the trusted connection, a second encryption key, wherein traffic on the trusted connection is encrypted using the first encryption key and the second encryption key.

20. The method according to claim 12, further comprising:
receiving, within the first nonce, a granular policy of the management device, the granular policy selected from a group consisting of: a user-based policy, an access level based policy, a time based policy, and an combination thereof; and
enforcing the granular policy on the trusted connection.
